(19) United States
(12) Patent Application Publication
(10) Pub. No.: US 2026/0259292 A1
(43) Pub. Date: Sep. 3, 2026

(54) METHOD FOR ELECTRONIC BEAM DIRECTION FINDING IN SATELLITE COMMUNICATION HYBRID TRACKING SYSTEM

(71) Applicant: YTTEK Technology Corp., Zhubei City (TW)

(72) Inventor: CHUNG-LIEN HO, Zhubei City (TW)

(21) Appl. No.: 19/390,789

(22) Filed: Nov. 17, 2025

Related U.S. Application Data
(60) Provisional application No. 63/765,407, filed on Feb. 28, 2025.

(51) Int. Cl. G01S 3/42; H04W 84/06

(52) U.S. Cl. CPC G01S 3/42; H04W 84/06

(57) ABSTRACT

A method for electronic beam direction finding in a satellite communication hybrid tracking system is disclosed, wherein electrical adjustment following mechanical adjustment obtains an equivalent dynamic electronic beam direction. The method ensures that the overall beam direction can be accurately pointed toward the target satellite by dynamically updating the electronic beam direction based on a user terminal (UT) mechanical antenna orientation and an incoming path direction of the target satellite relative to an antenna broadside.

This application claims the priority benefit of provisional patent application No. 63/765,407 titled “METHOD FOR ELECTRONIC BEAM DIRECTION FINDING IN SATELLITE COMMUNICATION HYBRID TRACKING SYSTEM” filed on 28 Feb. 2025, the disclosure of which is incorporated by reference herein in its entirety.

### BACKGROUND OF THE INVENTION

### Field of Invention

The present invention relates to the field of satellite communications and more particularly to a method for electronic beam direction finding in a satellite communication hybrid tracking system.

### Description of the Related Art

Satellite communication involves the transmission of signals via electromagnetic beams between user terminals (UTs) located on the Earth's surface and target satellites in orbit. The UT includes fixed communication equipment or mobile communication equipment, with the latter installed on movable platforms such as ships and vehicles. To ensure accurate link transmission, an antenna of the UT must align their beams with the target satellite.

The antenna achieves accurate link transmission by using beam directivity to focus signals toward the target satellite. When relative motion occurs between the antenna and the target satellite, the antenna must dynamically track the satellite to maintain beam alignment.
Reference: 3GPP, “Study on channel model for frequencies from 0.5 to 100 GHz,” TR 3GPP 38.901, V17.0.0, 2022-03.

### SUMMARY OF THE INVENTION

The primary objective of the present invention is to provide a method for electronic beam direction finding in a satellite communication hybrid tracking system.

To achieve this objective, the present invention provides a method for electronic beam direction finding in a satellite communication hybrid tracking system, executed when an antenna of a user terminal (UT) on the Earth's surface is in relative motion with a target satellite in orbit. The method comprises a pure mechanical tracking mode and a hybrid tracking mode, wherein:
the pure mechanical tracking mode is performed using a mechanical triple-axis shaft of the antenna with a fixed phase to obtain an antenna broadside direction (\hat{θ}ₒ, \hat{φ}ₒ), wherein (\hat{θ}ₒ, \hat{φ}ₒ)=(\hat{θ}ₘ, \hat{φ}ₘ)≡(π/2, 0);
the hybrid tracking mode initially performs a coarse tracking over a large tracking scope by a one-step mechanical adjustment, and subsequently performs a fine tracking within a small tracking scope by an electrical adjustment;
the mechanical adjustment aligns the antenna broadside direction by adjusting a bearing angle, an elevation angle, and a slant angle of the antenna using the mechanical triple-axis shaft, and the electrical adjustment fine-tunes the beam direction using a uniform planar array of a phased array antenna; and
the updated beam direction is calculated in a local coordinate system based on an attitude of the antenna and a relative direction of the target satellite, so as to maintain alignment between the antenna broadside direction and an incoming path direction of the target satellite.

By combining the mechanical triple-axis adjustment with an electronic phase compensation mechanism, the method disclosed herein achieves accurate and responsive beam alignment during relative motion between the UT and the target satellite, and effectively balances response time and resource consumption while maintaining high-precision beam alignment capability, thereby improving link stability and adaptability of the overall satellite communication system.

### BRIEF DESCRIPTION OF THE DRAWINGS

FIG. 1 is some components of ship motion during navigation;

FIG. 2 is a block diagram illustrating the complete beam tracking mechanism defined in four key frames according to the present invention;

FIG. 3 is a schematic diagram illustrating the user terminal (UT) beam tracking as implemented by the present invention;

FIG. 4 is a block diagram illustrating the frame structure of beam tracking in the present invention; and

FIG. 5 is a flowchart for beam pointing calculation according to the present invention.

### DETAILED DESCRIPTION OF THE PREFERRED EMBODIMENTS

The accompanying drawings illustrate embodiments of a method for electronic beam direction finding in a satellite communication hybrid tracking system. These embodiments are provided for illustrative purposes only and do not limit the scope of the invention.

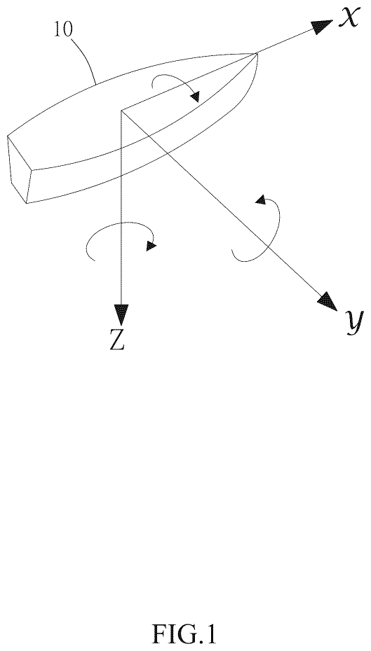

The method for electronic beam direction finding in a satellite communication hybrid tracking system operates when a user terminal (UT) 10, located on the Earth's surface, is in relative motion with respect to a target satellite (not shown) in orbit, as shown in FIG. 1. In this hybrid tracking system, an antenna 20 of the UT 10 performs electronic beam direction finding to align a transmission beam with the target satellite.

FIG. 1 illustrates a schematic diagram of six degrees of freedom of the motion state of the UT 10 when the UT 10 is a ship. The six degrees of freedom include rotation of the UT 10 around an X-axis in a navigation direction to form roll, rotation around a Y-axis in a broadside direction to form pitch, and rotation around a Z-axis in a gravity direction to form yaw, all of which affect beam alignment. The six degrees of freedom further include longitudinal translation (surge) of the UT 10 along the X-axis, lateral translation (sway) of the UT 10 along the Y-axis, and vertical translation (heave) of the UT 10 along the Z-axis. The longitudinal translation and the lateral translation affect the position reference of the antenna 20 and have secondary effects on the instantaneous phase of the antenna 20, and the vertical translation causes changes in the height of the antenna 20, thereby affecting estimation of an incoming angle.

When the antenna 20 of the UT 10 establishes a network connection with the target satellite, the antenna 20 initiates a beam tracking procedure for the target satellite after an initial search.

The beam tracking procedure performed by the antenna 20 to track the target satellite includes three tracking modes: a pure mechanical tracking mode, a pure electrical tracking mode, and a hybrid tracking mode that combines mechanical and electrical methods.

In the pure mechanical tracking mode, tracking is performed by a mechanical triple-axis shaft, also referred to as a mechanical triple-axis transmission shaft, with a fixed phase to obtain an antenna broadside direction (\hat{θ}ₒ, \hat{φ}ₒ)=(\hat{θ}ₘ, \hat{φ}ₘ)=(π/2, 0) of horn antennas. The pure mechanical tracking mode is characterized by low accuracy, lossless large-angle scanning, slow operating speed, the presence of mechanical wear issues, and low cost.

In the pure electrical tracking mode, tracking is based on results of the pure mechanical tracking mode and is performed using dynamically adjustable phase shifters. The pure electrical tracking mode is characterized by high accuracy, significant losses during large-angle scanning, fast operation speed, no mechanical wear issues, and high cost.

In the hybrid tracking mode, the mechanical triple-axis shaft and the phase shifters are combined to balance the advantages and disadvantages of the pure mechanical tracking mode and the pure electrical tracking mode.

In the hybrid tracking mode, a coarse tracking over a large (coarse) tracking scope is initially performed through a one-step mechanical adjustment, such as programmed tracking, and a fine tuning within a small (fine) tracking scope is subsequently performed through a one-step electrical adjustment or a multi-step electrical adjustment, such as step tracking.

The one-step mechanical adjustment and the one-step electrical adjustment are performed by programmed tracking based on geographical locations of the target satellite and the antenna 20 of the UT 10.

The multi-step electrical adjustment is performed by step-tracking based on previous tracking results according to a received signal strength indicator (RSSI), wherein the step-tracking method comprises at least one of a direct search method, a gradient method, and a quadratic approximation (curve-fitting) method.

An antenna pointing at a receiving end (RX) of the user terminal (UT) 10 refers to an antenna 20 of the UT 10 pointing toward a target satellite, and is defined as follows:

Definition 1: Beam alignment is defined on the antenna 20 of the UT 10, wherein an antenna coordinate system ( [symbol] -frame) is oriented (bearing, elevation, and slant) according to the attitude of the antenna 20 (i.e., a body coordinate system, ( [symbol] -frame)) and the relative position of the target satellite, by setting a bearing angle \hat{α}ᵣₓ, an elevation angle \hat{β}ᵣₓ, and a slant angle \hat{γ}ᵣₓ, to direct the plane normal of the antenna 20 (i.e., the antenna broadside direction (\hat{θ}ₒ, \hat{φ}ₒ)) toward the target satellite, wherein the attitude of the antenna 20 is defined by the body coordinate system relative to a North-East-Down coordinate system (also known as a NED coordinate system or [symbol] -frame).

Definition 2: An antenna field pattern can be defined in a global coordinate system (GCS) (as shown in the reference), i.e., an Earth-Centered Earth-Fixed (ECEF) coordinate system (also known as an ε-frame), and the field pattern can be transformed to any local coordinate system (LCS) through coordinate transformation (CT).

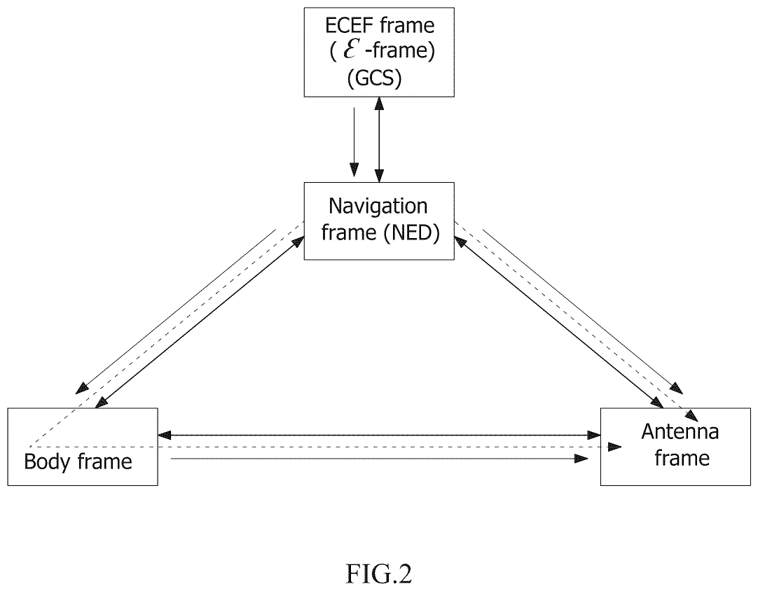

According to the above definition, the overall beam tracking performance should be evaluated from the ε-frame to the [symbol] -frame, wherein the beam tracking mechanism considers the ECEF coordinate system (ε-frame) using four key coordinate systems as shown in FIG. 2, to effectively evaluate the performance generated by the attitude and relative position information of the antenna 20. These four key coordinate systems are the ε-frame, the [symbol] -frame, the [symbol] -frame, and the [symbol] -frame.

An origin of the ECEF coordinate system is set at the Earth's center of mass, and a body position of the antenna 20 is provided by GPS and transformed to the navigation coordinate system through a rotation matrix [symbol] . The navigation coordinate system takes a current ground position as an origin and serves as a reference coordinate system for describing the reference of the body attitude of the antenna 20. the body coordinate system defines the yaw, pitch, and roll of the UT 10, wherein the body attitude information is provided by an inertial measurement unit (IMU) or other attitude sensors, and the body attitude relative to the navigation coordinate system is transformed through a rotation matrix [symbol] . The antenna coordinate system defines the actual pointing of the antenna 20, wherein the bearing angle, the elevation angle, and the slant angle are controlled by a mechanical triple-axis shaft, and the direction of the antenna 20 relative to the body coordinate is transformed through a rotation matrix [symbol] .

A dynamic beam alignment is calculated based on the direction of the antenna 20 relative to the body coordinate, compensating for motion errors through real-time sensors and outputs of the mechanical triple-axis shaft, and transformed via the rotation matrix [symbol] . Static beam alignment is based on the direction of the antenna 20 relative to the navigation coordinate, using ephemeris data for static calculation, and completing the coordinate transformation through the rotation matrix [symbol] .

Performance evaluation formulas are as follows:

Body attitude caused by navigation or perturbation within the [symbol] -frame: [symbol] = [symbol] =C₁(ι)C₂(ν)C₃(μ), and [symbol] =C₂(−φ_{U}−90°)C₃(λ_{U}).

Beam alignment (estimation):

$${\hat{C}}_{𝒜 ℬ} = {\hat{C}}_{𝒜 𝒩} {\hat{C}}_{𝒩 ℬ} = {\hat{C}}_{𝒜 𝒩} {\hat{C}}_{ℬ 𝒩}^{- 1} ≡ {C}_{1} ( {\hat{γ}}_{rx} ) {C}_{2} ( {\hat{β}}_{rx} ) {C}_{3} ( {\hat{α}}_{rx} ) ,$$

and [symbol] =C₁(η)C₂(κ)C₃(ϵ).

Beam alignment performance evaluation:

$${\hat{C}}_{𝒜 ℰ} = {\hat{C}}_{𝒜 ℬ} {C}_{ℬ ℰ} = {\hat{C}}_{𝒜 𝒩} {\hat{C}}_{ℬ 𝒩}^{- 1} {C}_{ℬ 𝒩} {C}_{𝒩ℰ} = {\hat{C}}_{T} ≡ {C}_{1} ( {\hat{γ}}_{T} ) {C}_{2} ( {\hat{β}}_{T} ) {C}_{3} ( {\hat{α}}_{T} ) = {\hat{C}}_{𝒜 𝒩} {C}_{𝒩 ℰ} ( if {\hat{C}}_{ℬ𝒩} = {C}_{ℬ 𝒩} ) = {C}_{𝒜 𝒩} {C}_{𝒩 ℰ} ( if {\hat{C}}_{ℬ 𝒩} = {C}_{ℬ 𝒩} , {\hat{C}}_{𝒜 𝒩} = {C}_{𝒜 𝒩} ) = {C}_{𝒜 ℰ} ≡ {C}_{1} ( {\tilde{γ}}_{T} ) {C}_{2} ( {\tilde{β}}_{T} ) {C}_{3} ( {\tilde{α}}_{T} ) ( if {\hat{C}}_{ℬ𝒩} = {C}_{ℬ 𝒩} , {\hat{C}}_{𝒜 𝒩} = {C}_{𝒜 𝒩} ) .$$

The signal from the target satellite arrives at the antenna 20 of the UT 10 with an equivalent incoming path direction (θ′_{ZOA}, φ′_{AOA}) with respect to the local coordinate system (LCS) (i.e., the antenna coordinate system of the UT 10), when the antenna (‘normal/broadside’) is oriented as much as possible toward the target satellite by the mechanical triple-axis shaft of the antenna 20. The overall channel coefficient is defined as:

$$Formula ( 1 )$$

$${h}_{m , n} ( t ) = \sqrt{{P}_{T}} {a}_{F} {c}_{F , m , n} {e}^{{jk}_{c} v {′}_{U} t} {e}^{{jk}_{c} ( ( n - 1 ) {d}_{y} sin {θ}_{ZOA}^{′} sin {ϕ}_{AOA}^{′} + ( m - 1 ) {d}_{z} cos {θ}_{ZOA}^{′} )}$$

Wherein, P_{T} represents transmit power from the target satellite,

$${a}_{F} ≡ \frac{{e}^{- j {k}_{c} D}}{2 {k}_{c} D}$$

represents the incoming path fading gain with k_{c}≡2π/λ, and D represents a distance between the target satellite and the antenna 20; c_{F,m,n} represents antenna polarization coupling between the target satellite and the (m, n)^{th} element of the uniform planar array at the antenna 20, as a function of (θ′_{ZOD}, φ′_{AOD}) and (θ′_{ZOA}, φ′_{AOA}), wherein (θ′_{ZOD}, φ′_{AOD}) represents a departure path direction relative to the local coordinate system from the targe satellite.

(dₓ, d_{y}, d_{z}) represents a spacing of the antenna 20 along (x, y, z) axis in the LCS; v′_{U} represents velocity (magnitude and direction) of the antenna 20, wherein (θᵥ, φᵥ) represents a moving direction (elevation angle, bearing angle) of the velocity of the antenna 20 with respect to the [symbol] -frame caused by navigation or perturbation.

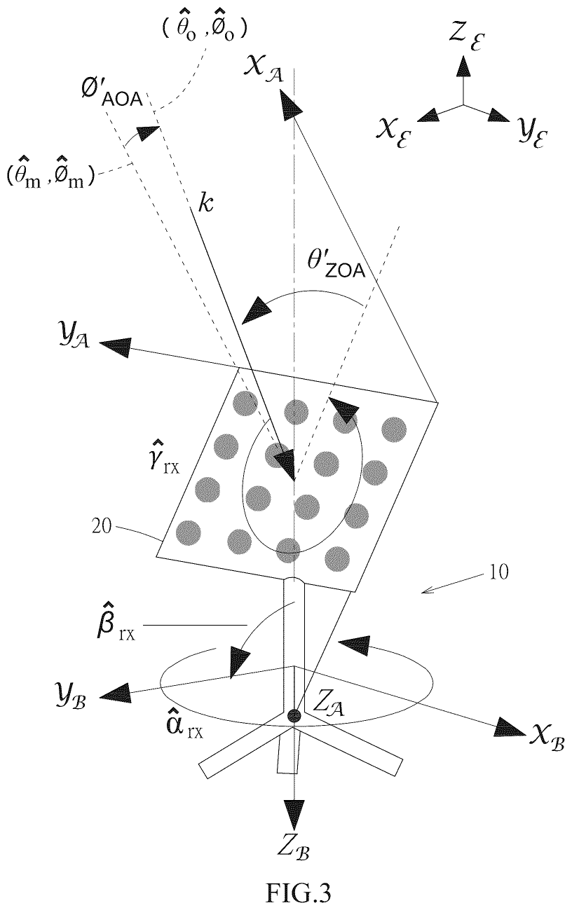

Based on the previous Formula (1), when an overall beam direction (\hat{θ}ₒ, \hat{φ}ₒ) obtained by mechanical and electrical adjustments is consistent with the incoming path direction of the target satellite (θ′_{ZOA}, φ′_{AOA}), an optimal alignment (\hat{θ}ₒ, \hat{φ}ₒ)=(θ′_{ZOA}, φ′_{AOA}) is achieved after the mechanical adjustment by the mechanical triple-axis shaft of the antenna 20. The hybrid beam tracking mechanism is illustrated in FIG. 3.

Calculation of key parameters (θ′_{ZOA}, φ′_{AOA}):

$${θ}_{Z O A}^{′} = {cos}^{- 1} ( {1}_{3}^{T} {ρ}_{r x}^{′} ) , {ϕ}_{A O A}^{′} = {tan}^{- 1} ( {1}_{2}^{T} {ρ}_{r x}^{′} / {1}_{1}^{T} {ρ}_{r x}^{′} ) , {ρ}_{r x}^{′} = {\hat{C}}_{T} {ρ}_{r x} ,$$

$${\hat{C}}_{T} = {\hat{C}}_{𝒜 ℰ} = {C}_{1} ( {\hat{γ}}_{T} ) {C}_{2} ( {\hat{β}}_{T} ) {C}_{3} ( {\hat{α}}_{T} ) ,$$

$${\hat{C}}_{T} = {\hat{C}}_{𝒜 ℰ} = {\hat{C}}_{𝒜 𝒩} {\hat{C}}_{ℬ 𝒩}^{- 1} , {C}_{ℬ 𝒩} {C}_{𝒩ℰ} = {\hat{C}}_{𝒜 𝒩} {\hat{C}}_{ℬ 𝒩} {C}_{ℬ 𝒩} {C}_{𝒩 ℰ} = {\hat{C}}_{𝒜 ℬ} {C}_{ℬ 𝒩} {C}_{𝒩 ℰ} = \frac{{C}_{1} ( {\hat{γ}}_{r x} ) {C}_{2} ( {\hat{β}}_{r x} ) {C}_{3} ( {\hat{α}}_{r x} )}{≡ {\hat{C}}_{𝒜 ℬ}} {C}_{ℬ𝒩} {C}_{𝒩 ℰ} .$$

(\hat{γ}_{T}, \hat{β}_{T}, \hat{α}_{T}) is the Euler angles in the [symbol] -frame with respect to the ε-frame by the mechanical adjustment;

$${ρ}_{rx} = [ \begin{matrix}sin {θ}_{ZOA} cos {ϕ}_{AOA} \\ sin {θ}_{ZOA} sin {ϕ}_{AOA} \\ cos {θ}_{ZOA}\end{matrix} ] ;$$

(θ_{ZOA}, φ_{AOA}) (=(θ_{ZOD}, φ_{AOD})) is the incoming direction of the target satellite in the ε-frame.

The target satellite's incoming path direction (θ′_{ZOA}, φ′_{AOA}) is a function of (\hat{α}ᵣₓ, \hat{β}ᵣₓ, \hat{γ}ᵣₓ), that is (θ′_{ZOA}, φ′_{AOA})=f(\hat{α}ᵣₓ, \hat{β}ᵣₓ, \hat{γ}ᵣₓ).

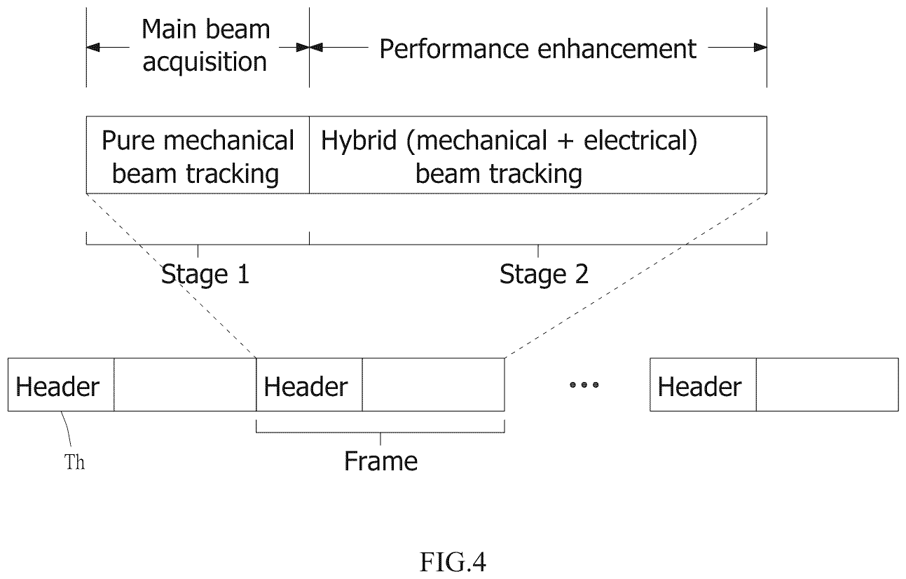

The beam tracking system is performed in hybrid tracking mode, including a first stage and a second stage. The first stage performs main beam acquisition (within the 3 dB beamwidth) based on a coarse tracking mechanism, completing pure mechanical beam tracking within a predefined frame header Tₕ to achieve minimum link budget requirements. A frame structure for hybrid beam tracking is shown in FIG. 4.

The second stage performs a performance enhancement using coarse and fine beams adjustments for hybrid beam tracking comprising mechanical and electrical methods. This can further enhance tracking performance, including improvements in tracking accuracy, tracking time, and addressing wear-and-tear issues.

The hybrid beam tracking includes consecutively executed Step 1 and Step 2, wherein Step 1 involves the mechanical adjustment using the mechanical triple-axis shaft of the antenna 20 to coarsely adjust (coarse adjustment) the bearing angle, elevation angle, and slant angle of the antenna 20. In a geostationary orbit (GEO) application, the slant angle can be adjusted by mechanical operation alone. This step does not provide additional degrees-of-freedom (DoF) on an x-axis of the mechanical triple-axis shaft for electrical compensation in the slant angle direction.

Following the Step 1, the Step 2 involves the electrical adjustment, performed by the uniform planar array (UPA) of a phased antenna, used to fine-tune the beam direction, aiming at an angle-of-arrival (AOA) φ′_{ZOA} and a zenith-of-arrival (ZOA) θ′_{ZOA} of the incoming signal from the target satellite.

Additional degrees-of-freedom (DoF) in a yz-plane are provided by two-dimensional electronic phase shifters to further improve beam accuracy of beam pointing to AOA and ZOA.

In the mechanical adjustment of the hybrid tracking mode, after triple-axis angles (\hat{α}ᵣₓ, \hat{β}ᵣₓ, \hat{γ}ᵣₓ) of the antenna 20 are set by the mechanical triple-axis shaft, an equivalent beam direction with a fixed phase (\hat{θ}ₒ, \hat{φ}ₒ)≡(π/2, 0) is obtained. A pointing error (θₑ, φₑ)≡(\hat{θ}ₘ−θ′_{ZOA}, \hat{φ}ₘ−φ′_{AOA}) caused by the mechanical adjustment is a function of the antenna orientation (\hat{α}ᵣₓ, \hat{β}ᵣₓ, \hat{γ}ᵣₓ) relative to the incoming direction of the target satellite, i.e., (θ′_{ZOA}, φ′_{AOA})=f(\hat{α}ᵣₓ, \hat{β}ᵣₓ, \hat{γ}ᵣₓ). The mechanical adjustment of the mechanical triple-axis shaft of the antenna 20 (\hat{α}ᵣₓ, \hat{β}ᵣₓ, \hat{γ}ᵣₓ) (i.e., the bearing angle, the elevation angle, and the slant angle) results in an equivalent beam direction with a fixed phase (i.e., antenna broadside direction) (\hat{θ}ₘ, \hat{φ}ₘ)≡(π/2, 0), allowing the antenna broadside to point toward the target satellite as much as possible.

The hybrid tracking mode then obtains an equivalent beam direction (\hat{θ}ₑ, \hat{φ}ₑ) through the electrical adjustment of the dynamically adjustable phase shifters of the antenna 20. The electrical adjustment obtains an equivalent beam direction (\hat{θ}ₑ, \hat{φ}ₑ) with a dynamic phase (\hat{θ}ₑ, \hat{φ}ₑ)=f(\hat{α}ᵣₓ, \hat{β}ᵣₓ, \hat{γ}ᵣₓ), which is a function of antenna orientation (bearing, elevation, and slant). (\hat{θ}ₒ, \hat{φ}ₒ) represents the overall beam direction obtained by combining mechanical and electrical adjustments. The electrical adjustment of the antenna 20 phase shifter (i.e., (\hat{θ}ₑ, \hat{φ}ₑ)) serves as an equivalent dynamic beam direction (\hat{θ}ₑ, \hat{φ}ₑ)=f(\hat{α}ᵣₓ, \hat{β}ᵣₓ, \hat{γ}ᵣₓ) after mechanical adjustment such that the overall BD (\hat{θ}ₒ, \hat{φ}ₒ) can be point to the incoming path (θ′_{ZOA}, φ′_{AOA}) of the target satellite ideally, if the electrical beam direction (\hat{θ}ₑ, \hat{φ}ₑ) is updated and equivalent to the mechanical adjustment's pointing error (\hat{θ}ₑ, \hat{φ}ₑ).

$$( {\hat{θ}}_{e} , {\hat{ϕ}}_{e} ) = f ( {\hat{α}}_{r x} , {\hat{β}}_{r x} , {\hat{γ}}_{r x} ) = ( {θ}_{e} , {ϕ}_{e} ) = ( {\hat{θ}}_{m} - {θ}_{ZOA} , {\hat{ϕ}}_{m} - {ϕ}_{A O A}^{′} ) = ( π / 2 - {θ}_{ZOA}^{′} , - {ϕ}_{A O A}^{′} ) = ( π / 2 - {\hat{θ}}_{o} , - {\hat{ϕ}}_{o} ) .$$

Eventually, (\hat{θ}ₒ, \hat{φ}ₒ)=(θ′_{ZOA}, φ′_{AOA})=(π/2−\hat{θ}ₑ, 0−\hat{φ}ₑ)=(\hat{θ}ₘ−\tilde{θ}ₑ, \hat{φ}ₘ−\hat{φ}ₑ)=f(\hat{α}ᵣₓ, \hat{β}ᵣₓ, \hat{γ}ᵣₓ).

### Summary of the Hybrid Tracking Process

In the mechanical adjustment:

1. The incoming path direction of the target satellite at the antenna broadside of the antenna 20 is given by:

$$( {θ}_{ZOA}^{′} , {ϕ}_{A O A}^{′} ) = f ( {\hat{α}}_{rx} , {\hat{β}}_{r x} , {\hat{γ}}_{r x} )$$

2. The antenna orientation according to the triple-axis shaft (bearing, elevation, and slant), is expressed as:

$$( {\hat{α}}_{rx} , {\hat{β}}_{rx} , {\hat{γ}}_{r x} )$$

3. The corresponding fixed beam direction is:

$$( {\hat{θ}}_{m} , {\hat{ϕ}}_{m} ) ≡ ( π / 2 , 0 )$$

4. The pointing error is:

$$( {θ}_{e} , {ϕ}_{e} ) ≡ ( {\hat{θ}}_{m} - {θ}_{ZOA}^{′} , {\hat{ϕ}}_{m} - {ϕ}_{A O A}^{′} )$$

In the electrical adjustment:

1. The dynamic phase shifter of the antenna 20 (i.e., beam direction with dynamic phase) is:

$$( {\hat{θ}}_{e} , {\hat{ϕ}}_{e} )$$

2. The overall beam direction is:

$$( {\hat{θ}}_{o} , {\hat{ϕ}}_{o} )$$

3. The goal of the adjustment is:

$$( {\hat{θ}}_{o} , {\hat{ϕ}}_{o} ) = ( {θ}_{ZOA}^{′} , {ϕ}_{A O A}^{′} )$$

4. The solution for dynamic phase adjustment is:

$$( {\hat{θ}}_{e} , {\hat{ϕ}}_{e} ) = ( {θ}_{e} , {ϕ}_{e} ) = f ( {\hat{α}}_{r x} , {\hat{β}}_{r x} , {\hat{γ}}_{r x} )$$

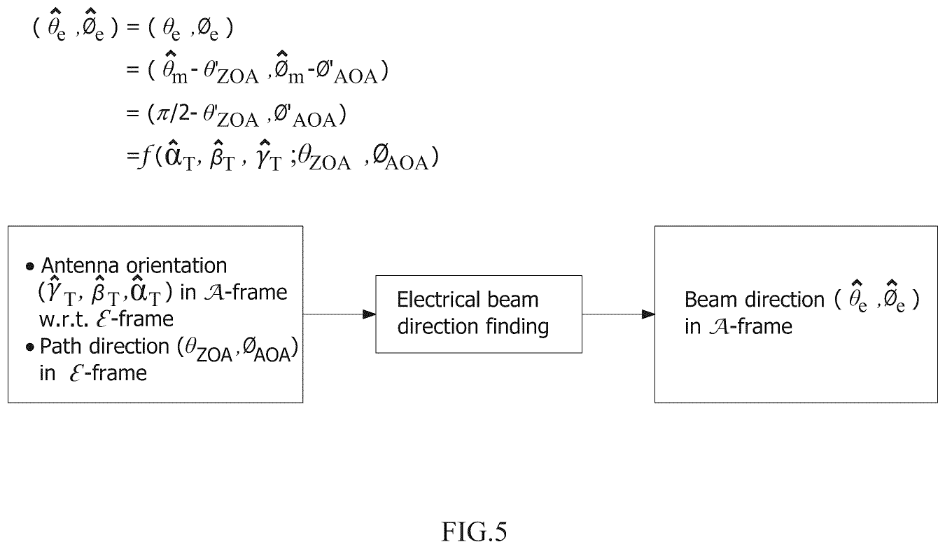

Referring to FIG. 5, the electronic beam direction (De, Pe) calculation is:

$$( {\hat{θ}}_{e} , {\hat{ϕ}}_{e} ) = ( {θ}_{e} , {ϕ}_{e} ) = ( {\hat{θ}}_{m} - {θ}_{ZOA}^{′} , {\hat{ϕ}}_{m} - {ϕ}_{A O A}^{′} ) = ( π / 2 - {θ}_{ZOA}^{′} , - {ϕ}_{A O A}^{′} ) = f ( {\hat{α}}_{T} , {\hat{β}}_{T} , {\hat{γ}}_{T} ; {θ}_{ZOA} , {ϕ}_{A O A} ) .$$

The mechanism for achieving fine beam tracking through the electrical adjustment includes a one-shot refinement and a step-by-step refinement, where the one-shot refinement is a beam tracking performed outside a main beam area by determining a peak location (PL) of a beamforming output power according to a received signal subspace. The peak location may also be determined through program control during coarse tracking.

The step-by-step based refinement is a beam tracking performed inside the main beam area (e.g., within 3-dB beamwidth). In this approach, the PL is determined step-by-step according to the received signal strength indicator (RSSI).

The current orientation of the antenna 20 caused by the mechanical triple-axis shaft is represented as (\hat{α}ᵣₓ, \hat{β}ᵣₓ, \hat{γ}ᵣₓ). A reference antenna orientation, corresponding to the antenna broadside direction, is denoted as (α_{Ref}, β_{Ref}, γ_{Ref}), which is equal to the previous antenna orientation: (α_{Ref}, β_{Ref}, γ_{Ref})=(\hat{α}_{n-τ}, \hat{β}_{n-τ}, \hat{γ}_{n-τ}). An orientation error caused by the mechanical adjustment is expressed as: (αₑ, βₑ, γₑ)≡(\hat{α}ᵣₓ, \hat{β}ᵣₓ, \hat{γ}ᵣₓ)−(α_{Ref}, β_{Ref}, γ_{Ref})=(\hat{α}ₙ−α_{Ref}, \hat{β}ₙ−β_{Ref}, \hat{Γ}ₙ−γ_{Ref}).

A half field-of-view (FoV) for fine beam tracking is defined as (A_{HF}, B_{HF}). For geostationary orbit (GEO) satellites, the slant angle is updated only through the mechanical adjustment. In contrast, for non-GEO satellites, no slant angle update is required. Additionally, a half 3 dB beamwidth is defined as (A_{H3 dB}, B_{H3 dB}).

The tracking modes of the antenna 20 are categorized based on the tracking scope as follows:
Mode 0: Large-scope tracking;
Mode 1: Medium-scope tracking; and
Mode 2: Small-scope tracking.

The method for electronic beam direction finding in a satellite communication hybrid tracking system disclosed in the present invention achieves accurate and responsive beam alignment when there is relative motion between the target satellite and the antenna 20 of the UT 10 by combining the mechanical triple-axis adjustment with the electronic phase compensation mechanism, and the method has the following technical effects:

1. Achieves fast search and coarse beam guidance toward the target satellite, reducing time required for initial beam acquisition.

2. Performs fine adjustment through electronic phase control to improve accuracy of beam direction estimation and reduce pointing errors.

3. Dynamically switches tracking modes according to communication link quality indicators (e.g., low-frequency updates for wide-area search mode and high-frequency updates for fine adjustment mode) to balance system response speed and computational load.

4. Reduces reliance on frequent mechanical adjustments, thereby minimizing structural wear and improving long-term system stability.

5. Provides adaptability for various terminal equipment platforms, including fixed ground stations, mobile ground or maritime systems, and airborne communication platforms, with good implementability and flexibility.

What is claimed is:

1. A method for electronic beam direction finding in a satellite communication hybrid tracking system, executed when an antenna of a user terminal (UT) and a target satellite in orbit are in relative motion, the method comprising:
performing a pure mechanical tracking mode and a hybrid tracking mode;
wherein the pure mechanical tracking mode is performed using a mechanical triple-axis shaft with a fixed phase to obtain an antenna broadside direction (\hat{θ}ₒ, \hat{φ}ₒ), wherein (\hat{θ}ₒ, \hat{φ}ₒ)=(\hat{θ}ₘ, \hat{φ}ₘ)≡(π/2, 0);
the hybrid tracking mode initially performs a coarse tracking over a large tracking scope by a one-step mechanical adjustment, and subsequently performs a fine tracking within a small tracking scope by an electrical adjustment;
the mechanical adjustment aligns the antenna broadside direction by adjusting a bearing angle, an elevation angle, and a slant angle of the antenna using the mechanical triple-axis shaft, and the electrical adjustment fine-tunes a beam direction using a uniform planar array of a phased array antenna; and
an updated beam direction is calculated in a local coordinate system based on an attitude of the antenna and a relative direction of the target satellite so as to maintain alignment between the antenna broadside direction and an incoming path direction of the target satellite.

2. The method according to claim 1, wherein the one-step mechanical adjustment is a programmed tracking performed based on geographical locations of the target satellite and the antenna.

3. The method according to claim 1, wherein the electrical adjustment controls the uniform planar array of the antenna through phase shifters to perform one-shot refinement or step-by-step refinement.

4. The method according to claim 3, wherein the one-shot electrical refinement is a programmed tracking performed based on geographical locations of the target satellite and the antenna.

5. The method according to claim 3, wherein the step-by-step electrical refinement is performed based on a received signal strength indicator according to a previous tracking result, and the step-by-step electrical refinement employs at least one of a direct search method, a gradient method, and a quadratic approximation (curve-fitting) method.

6. The method according to claim 1, wherein when the antenna broadside direction of the antenna is oriented toward the target satellite through mechanical adjustment of the mechanical triple-axis shaft, a signal from the target satellite enters the antenna with an equivalent incoming path direction relative to a local coordinate system of the UT, and an overall channel coefficient is defined as follows:
$${h}_{m , n} ( t ) = \sqrt{{P}_{T}} {a}_{F} {c}_{F , m , n} {e}^{{jk}_{c} v {′}_{U} t} {e}^{{jk}_{c} ( ( n - 1 ) {d}_{y} sin θ {′}_{ZOA} sin ϕ {′}_{AOA} + ( m - 1 ) {d}_{z} cos θ {′}_{ZOA} )}$$
wherein P_{T} represents a transmit power of the target satellite,
$${a}_{F} ≡ \frac{{e}^{- j {k}_{c} D}}{2 {k}_{c} D}$$
represents a path fading gain from the target satellite to the antenna with k_{c}≡2π/λ, D represents a distance between the target satellite and the antenna, c_{F,m,n} represents a polarization coupling coefficient between the target satellite and an (m, n)^{th} element of the uniform planar array of the antenna as a function of an equivalent incoming angle and a departure path direction relative to the local coordinate system, (dₓ, d_{y}, d_{z}) represents a spacing of the antenna along the array axis (x, y, z), and v′_{U} represents a velocity of the antenna, wherein (θᵥ, φᵥ) represents a moving direction of the velocity of the antenna relative to a North-East-Down (N) coordinate frame caused by navigation or perturbation.
